(19) United States
(12) Patent Application Publication
(10) Pub. No.: US 2024/0270034 A1
(43) Pub. Date: Aug. 15, 2024

(54) DEVICE FOR FITTING AND REMOVING A TIRE ON A RIM

(71) Applicant: M & B ENGINEERING S.r.l., Reggio nell'Emilia (IT)

(72) Inventor: Cristiano TAROZZI, Reggio nell'Emilia (IT)

(73) Assignee: M & B ENGINEERING S.r.l., Reggio nell'Emilia (IT)

(21) Appl. No.: 18/561,319

(22) PCT Filed: May 13, 2022
(86) PCT No.: PCT/IB2022/054463

§ 371 Date: Nov. 16, 2023

(30) Foreign Application Priority Data
May 17, 2021 (IT) 102021000012638

(51) Int. Cl. B60C 25/138; B60C 25/05

(52) U.S. Cl. CPC B60C 25/138; B60C 25/0578; B60C 25/0593

(57) ABSTRACT

A device for fitting and removing a tire on a rim, comprises: a working assembly movable along at least one first direction to vary its level with respect to the rim and provided with at least one tool adapted to interact with the tire; where the working assembly comprises at least one supporting element movable along the first direction, at least one fitting tool and one removal tool of the tire which are separate from each other and locked together with the supporting element along the first direction, wherein the fitting tool and the removal tool are movable with respect to each other along at least one direction of work which is transverse with respect to the first direction.

### TECHNICAL FIELD

The present invention relates to a device for fitting and removing a tire on a rim.

### BACKGROUND ART

The operations of fitting and removing a tire on a rim require great care by the operator performing them in order to avoid excessive stress being applied onto the tire itself, which could result in damage both to the tire's sealing area (bead) with the rim and to the rim itself.

The automatic systems known to date for fitting and removing a tire, which have replaced the use of the hand lever over time, involve the use of tools, such as fasteners or hooks, which are forcefully inserted between the edge of the rim and the tire bead and which, by reversing the direction of the force applied, pull the bead out by bringing it above the edge of the rim.

Thus, the tools used in the automatic systems of known type actually replicate the action of the manual lever used in the past.

From this it follows that the stresses applied on the tire bead by the tool used, which forces the extraction (removal) from or the insertion (fitting) thereof into the seat by passing from under to the top of the rim edge and vice versa, are particularly strong.

In some machines, the tool has been made in such a way that it also operates as a guide for the bead, in order to reduce the stresses applied thereto, while being suitable only for the fitting or removing operation.

This led to the use of a working assembly, vertically movable in the direction of moving close to/away from the rim, provided with two tools, one of which is dedicated only to the removal operation and the other dedicated only to the fitting operation.

Alternatively, tools were made characterized by a single body having differentiated working areas, i.e., an area adapted to interact with the tire during the fitting phase and a different area adapted to interact with the tire during removal.

Some systems for fitting and removing a tire from a rim are known from US2009/7497761, US2002/0017368, US2017/9707810, US2013/0269880, US2016/0023524, US2016/0129739, US2016/0288598, US2018/0104997, US2018/0304704.

These solutions of known type do, however, have some drawbacks.

In particular, the tools (or areas) dedicated to each of the operational fitting and removing phases inevitably interfere or overlap with each other during the operation because the bead entry area into the seat and the bead exit area out of the seat are coincident.

In addition, the tool not used in the fitting/removing phase is forced against the rim as it still occupies a necessary overall space for the bead to enter/exit the rim seat(s), resulting in the risk of rim damage.

### DESCRIPTION OF THE INVENTION

The main aim of the present invention is to devise a device for fitting and removing a tire on a rim which allows optimizing the fitting and removing operations of a tire on a rim while reducing as much as possible the stresses exerted on the tire itself and avoiding damage to the rim.

Within this aim, one object of the present invention is to devise a device for fitting and removing a tire provided with two mutually separate tools wherein the unused tool applies no stress on the rim.

Yet another object is to devise a device for fitting and removing a tire which is as independent as possible from the operator's skills.

Not the least object of the present invention is to make a device for fitting and removing a tire on a rim which is easy to operate and inexpensive.

Another object of the present invention is to devise a device for fitting and removing a tire on a rim which can overcome the aforementioned drawbacks of the prior art within a simple, rational, easy and effective to use as well as inexpensive solution.

The aforementioned objects are achieved by this device for fitting and removing a tire on a rim according to claim 1.

### BRIEF DESCRIPTION OF THE DRAWINGS

Other characteristics and advantages of the present invention will become more apparent from the description of a preferred, but not exclusive, embodiment of a device for fitting and removing a tire on a rim, illustrated by way of an indicative, yet non-limiting example, in the accompanying tables of drawings in which:

FIG. 1 is an axonometric view of a tire-changing machine comprising a device for fitting and removing according to the invention;

FIG. 2 is an axonometric view of a device according to the invention in a first operational position;

FIG. 3 is a side elevation view of the operational position in FIG. 2;

FIG. 4 is an axonometric view of the device in FIG. 2 in a second operational position;

FIG. 5 is a side elevation view of the operational position in FIG. 4;

FIG. 6 is an axonometric view of the device in FIG. 2 in a third operational position;

FIG. 7 is a side elevation view of the operational position in FIG. 6;

FIG. 8 is a schematic representation of an alternative embodiment of a device according to the invention;

FIGS. 9 to 14 are schematic representations of the different operational phases of the tools of a device according to the invention.

### EMBODIMENTS OF THE INVENTION

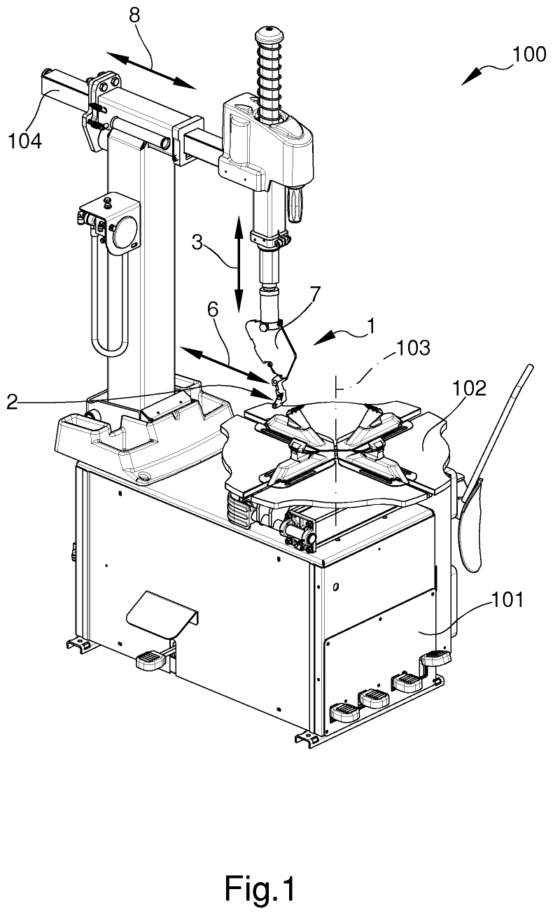

With particular reference to these figures, reference numeral 1 globally indicates a device for fitting and removing a tire P on/from a rim C. In FIG. 1, the device 1 is applied to a tire-changing machine 100 comprising a bedplate 101 on which a supporting assembly 102 of a rim C is mounted.

More particularly, the supporting assembly 102 comprises a spindle 103, rotating around its own axis, on which the rim C or the wheel (meant as the combination of rim C and tire P) to be machined is fixed by means of a corresponding clamping system.

The axis of rotation of the spindle 103 is generally vertical, as in the embodiment shown in FIG. 1.

The device 1 comprises a working assembly 2 movable along at least one first direction 3 to vary its height with respect to the rim C, moving close to/away from the supporting assembly 102, and provided with at least one tool 4,5 adapted to interact with the tire P.

More particularly, the machine 100 comprises one arm 104 supporting the working assembly 2. The arm 104 has an elongated conformation.

According to the invention, the working assembly 2 comprises a fitting tool 4 and a removal tool 5 of the tire P which are separate from each other and locked together along the first direction 3, where the fitting tool 4 and the removal tool 5 are movable with respect to each other along at least one direction of work 6 which is transverse with respect to the first direction 3.

Appropriately, the first direction 3 is oriented substantially vertically, and the direction of work 6 thus has at least one component transverse to the first direction 3, so as to allow the radial close/away movement with respect to the rim C.

In more detail, the working assembly 2 comprises at least one supporting element 7, movable along at least the first direction 3, and the tools 4 and 5 are locked together with the supporting element 7 along at least the first direction 3. Preferably, the fitting tool 4 protrudes inferiorly with respect the removal tool 5. The fitting tool 4 and the removal tool 5 face, in use, the same side with respect to the supporting element 7. More specifically, the fitting tool 4 and the removal tool 5 both face downwards.

The supporting element 7 is clamped in rotation. Specifically, the supporting element 7 is clamped in rotation around an axis parallel to the longitudinal development of the arm 104. The orientation of the tools 4 and 5 with respect to rim C thus remains fixed, in use.

In the embodiment shown in the figures, the fitting tool 4 has a recess, facing the opposite side with respect to the rim C (and thus with respect to the supporting assembly 102) adapted to receive the edge of the tire P. More particularly, the removal tool 5 is conformed substantially in the shape of a hook, so that it can engage the bead of the tire P, where the hook itself faces the opposite side with respect to the rim C (and thus with respect to the supporting assembly 102).

The working assembly 2, and thus also the supporting element 7, can also be moved along a second direction 8, transverse to the first direction 3, moving close to/away from the rim C in a radial pattern and, thus, to the supporting assembly 102. The fitting tool 4 and the removal tool 5 are locked together with the working assembly 2 along the second direction 8.

The first direction 3 and the second direction 8 belong to a common plane, identified in FIGS. 3, 5 and 7 with the reference letter R. In other words, by moving along the first direction 3 and along the second direction 8, the working assembly 2 allows the tools 4 and 5 to move close to/away from the rim C in both vertical and horizontal directions.

Thus, the direction of work 6 has at least one component parallel to the second direction 8.

Preferably, at least one of the tools 4 and 5 is hinged to the supporting element 7 around a relevant axis of work 9.

Conveniently, the device 1 comprises movement means 10 of at least one of the tools 4, 5 around the relevant axis of work 9. The movement means 10 are, e.g., of the type of an actuator device 11 provided with a body 11a associated with the supporting element 7 and with a stem 11b movable with respect to the body 11a and connected to at least one of the tools 4, 5 in a kinematic manner.

Advantageously, at least one of either the fitting tool 4 or the removal tool 5 is movable in rotation with respect to the other around an axis of rotation 12 transverse to the first direction 3 to displace along the direction of work 6.

In the preferred embodiments shown in the figures, the fitting tool 4 and the removal tool 5 are hinged to each other around the axis of rotation 12 which, therefore, is defined on both tools 4 and 5.

More particularly, the axis of rotation 12 is arranged transverse to the common plane R to which the first direction 3 and the second direction 8 belong.

Appropriately, at least one of either the fitting tool 4 or the removal tool 5 is movable in rotation with respect to the other around the axis of rotation 12.

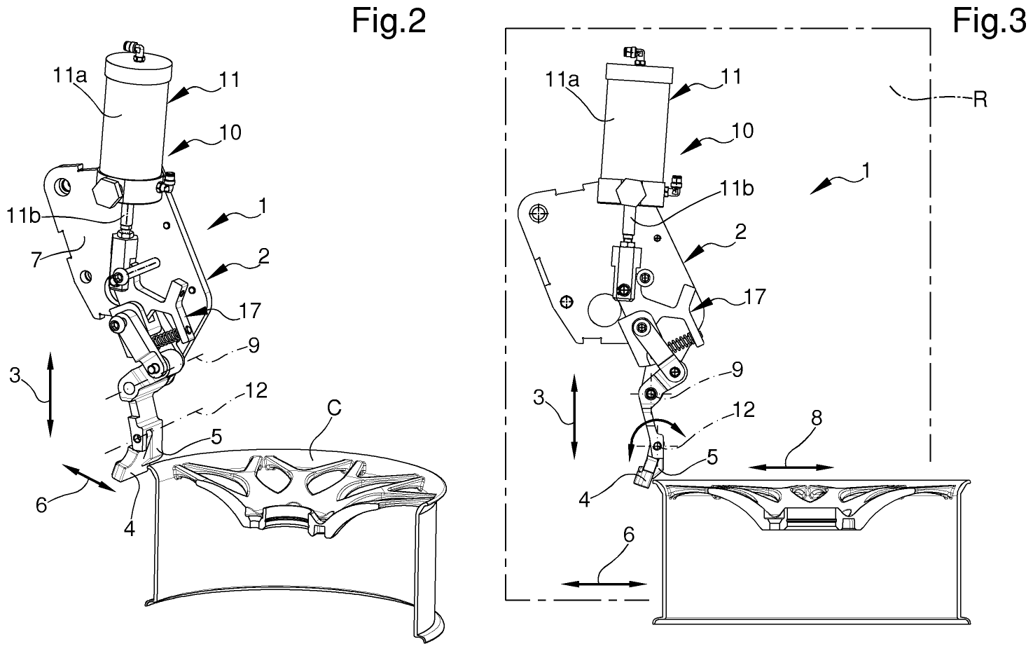

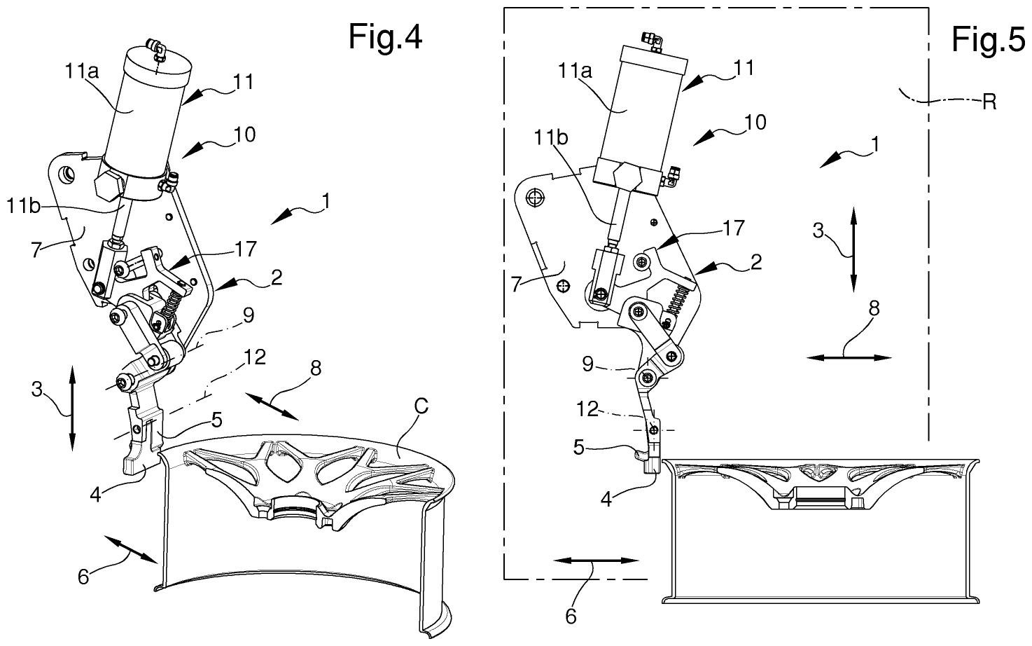

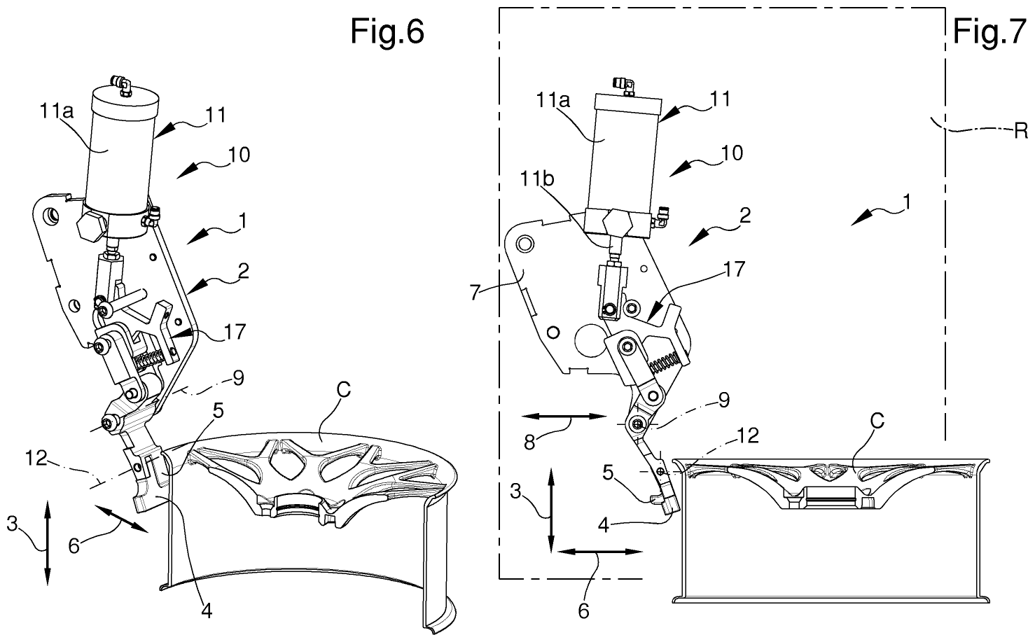

In one embodiment, such as the one shown in FIGS. 2 to 7, only one of either the fitting tool 4 or the removal tool 5 is movable with respect to the other around the axis of rotation 12.

In an alternative embodiment, both tools 4 and 5 are movable with respect to the other around the axis of rotation 12.

The axis of rotation 12 and the axis of work 9 are parallel to each other. More particularly, the axis of rotation 12 can be separate from or coincident with the axis of work 9.

In more detail, in case the axis of rotation 12 is separate from the axis of work 9, as in the embodiment shown in FIGS. 2 to 7, only one of either the fitting tool 4 or the removal tool 5, particularly the one of the two which is not hinged to the supporting element 7, is movable with respect to the other tool around the axis of rotation 12, whereas in the case wherein the axis of rotation 12 is coincident with the axis of work 9, both tools 4 and 5 are movable in rotation with respect to the other tool around the axis of rotation 12.

At least one of the tools 4 and 5 can be associated idle with the other tool 4, 5 around the axis of rotation 12.

Advantageously, the device 1 comprises operating means 13 at least one of the tools 4 and 5 along the direction of work 6.

More particularly, the operating means 13 are adapted to operate in rotation at least one of the tools 4 and 5 with respect to the other around the axis of rotation 12.

Appropriately, the operating means 13 comprise at least one actuating device 14 connected to at least one of the tools 4 and 5 in a kinematic manner to control the rotation thereof around the axis of rotation 12.

In detail, the actuating device 14 comprises at least one body 14a associated with the supporting element 7 and one stem 14b movable with respect to the body 14a and connected to a corresponding tool 4,5 in a kinematic manner. The stem 14b can be directly hinged to the tool 4,5 or can be connected thereto by interposition of a kinematic mechanism.

In the case where both tools 4, 5 are driven in rotation around the axis of rotation 12, the operating means 13 comprise two actuating devices 14, of which one is connected to the fitting tool 4 in a kinematic manner and the other is connected to the removal tool 5 in a kinematic manner.

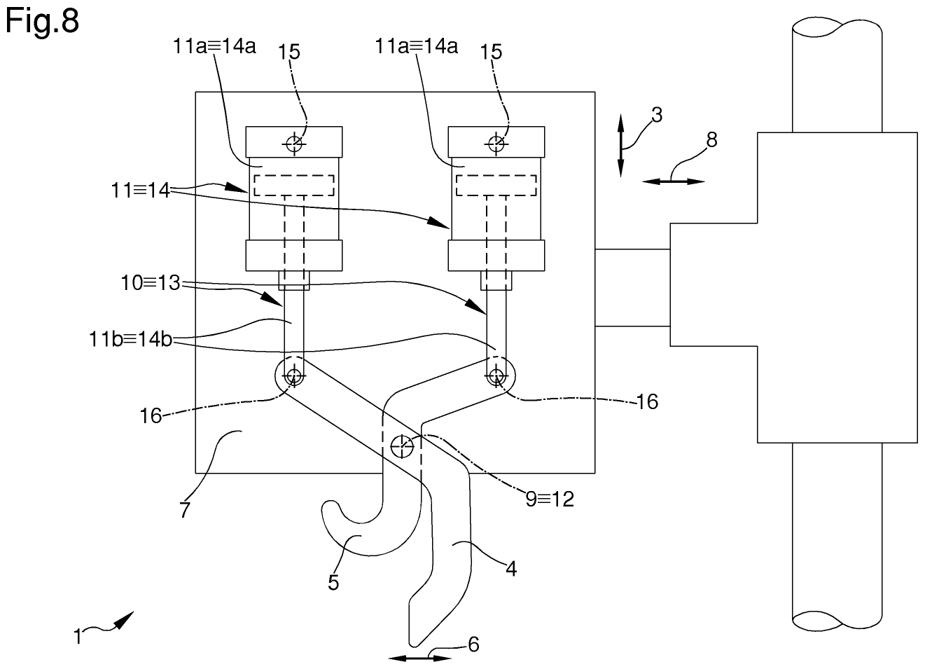

In the embodiment shown in FIG. 8, the operating means 13 thus comprise two actuating devices 14 having their bodies 14a hinged to the supporting element 7 around a relevant tilting axis 15 and their stems 14b connected to the corresponding tool 4,5 in a kinematic manner. More particularly, the stems 14b are hinged to the relevant tool 4,5 around a hinging axis 16 separate from the axis of rotation 12 and, as a result of their displacement, the fitting tool 4 and the removal tool 5 are driven in rotation around the axis of rotation 12.

In this embodiment, the tools 4 and 5 are associated in rotation with the supporting element 7 around the axis of rotation 12, which therefore coincides with the axis of work 9. Therefore, the movement means 10 coincide with the operating means 13.

In the embodiment shown in FIGS. 2 to 7, the removal tool 5 is hinged to the supporting element 7 around an axis of work 9 and the fitting tool 4 is associated movable in rotation with respect to the removal tool 5 around the axis of rotation 12. Thus, the fitting tool 4 is locked in rotation, in the absence of forces acting thereon, together with the removal tool 5 around the axis of work 9 and movable with respect thereto around the axis of rotation 12. As can be seen from the figures, the device 1 comprises an actuator device 11 the stem 11b of which is connected by a linkage 17 to the removal tool 5 in a kinematic manner. Appropriately, the fitting tool 4 is idly associated with the removal tool 5 around the axis of rotation 12. It follows, therefore, that in the absence of any force applied thereto, the fitting tool 4 follows the removal tool 5 in its displacements around the axis of work 9 while rotating with respect thereto around the axis of rotation 12 as a result of the interaction with the rim C or with the tire P. In this embodiment, the axis of work 9 around which the removal tool 5 rotates with respect to the supporting element 7 is thus separate from the axis of rotation 12 around which the fitting tool 4 rotates with respect to the removal tool itself.

The operating means 13 can thus be separate or coincident with the movement means 10 depending on whether the axis of rotation 12 is separate or coincident with the axis of work 9, respectively.

Alternative embodiments cannot however be ruled out wherein the tools 4 and 5 are movable by shift with respect to each other along the direction of work 6.

The operation of this invention is as follows.

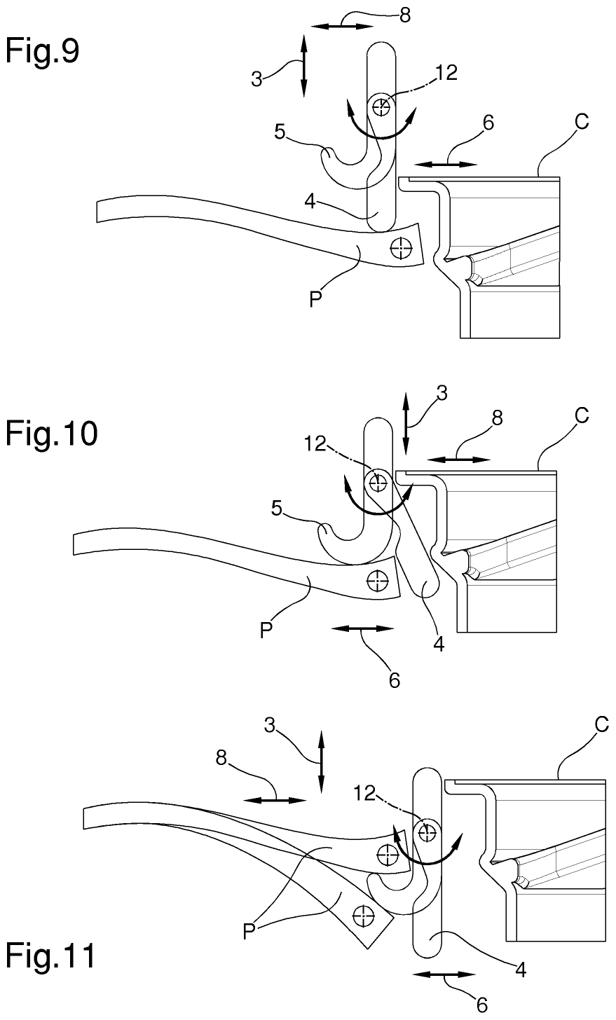

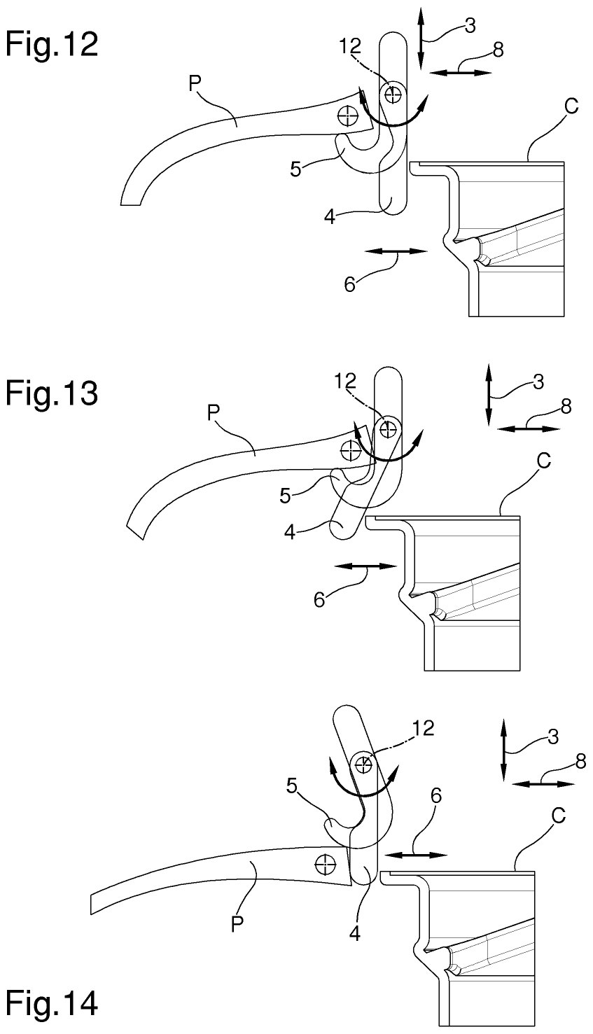

The operational phases of the device 1 during the fitting and removal operations of the tire P are shown in FIGS. 9 to 14.

Specifically, with the tire P mounted on the rim C, the working assembly 2 is moved downwards along the first direction 3 close to the rim C.

The fitting tool 4 which, as mentioned, protrudes inferiorly with respect to the removal tool 5, first contacts the tire P by pushing it downwards. The further descent of the working assembly 2 causes the fitting tool 4 to rotate around the axis of rotation 12 towards the rim C and the removal tool 5 to interact with the bead of the tire P. More specifically, the removal tool 5 moves below the tire P, actually engaging it. As a result of the displacement of the bead of the tire P above the removal tool 5, the fitting tool 4 rotates around the axis of rotation 12 again in the opposite direction to the previous one because the thrust exerted by the tire thereon is lost. These phases are shown in FIGS. 9 through 11.

At this point, the working assembly 2 is moved upwards along the first direction 3 so as to bring the bead of the tire P above the edge of the rim C.

Next, the working assembly 2 can move along the second direction 8 close to the rim C in order to bring the bead of the tire P closer to the rim itself.

After the tire P has passed beyond the edge of the rim C, the working assembly 2 moves along the second direction 8 close to the supporting assembly 102; as a result of this displacement, the fitting tool 4 interacts with the edge of the rim C and rotates around the axis of rotation 12 away from the rim itself so as not to interfere with the removal operation in progress. At this point the tire P is then removed from the rim C.

The fitting operation is carried out by placing the bead of the tire P above the edge of the rim C and by arranging the working assembly 2 above it.

Next, the working assembly 2 is moved downwards along the first direction 3 so that the fitting tool 4 first interacts with the tire P thus pushing it inside the seat of the rim C. During this operational phase, the removal tool 5 is rotated around the axis of rotation 12 so that the tire P leans against it to be guided during the rotation of the supporting assembly 102.

In the operation described above, the fitting tool 4 rotates around the axis of rotation 12 due to the interaction with the tire P and/or with the rim C. It cannot, however, be ruled out that the fitting tool 4 may be driven in rotation around the axis of rotation 12 by its operating means 13.

It has in practice been ascertained that the described invention achieves the intended objects, and in particular, the fact is emphasized that the device of the present invention due to the possibility of mutual movement of the tools in the direction of moving close to and away from the rim makes it possible to optimize the fitting and removal operations of a tire on a rim by minimizing the stresses exerted on the tire itself and avoiding damage to the rim.

In particular, the relative movement of the fitting and removal tools along the direction of work prevents the tool not used in the specific operation from interfering with the tire or rim.

Again, due to the relative movement between them along the direction of work, the tools can operate in conjunction with each other to achieve a synergistic effect.

Last but not least, the fact that the tools face the same side as the supporting element, thus resulting in always facing the rim at every operational phase, simplifies the fitting and removal operations since it minimizes intervention times.

1. A device for fitting and removing a tire on a rim, the device comprising:
a working assembly movable along at least one first direction to vary a level of the working assembly with respect to the rim and provided with at least one tool adapted to interact with the tire, wherein
said working assembly comprises at least one supporting element movable along said first direction, at least one fitting tool and one removal tool of the tire which are separate from each other and locked together with said supporting element along said first direction, wherein said fitting tool and said removal tool are movable with respect to each other along at least one direction of work which is transverse with respect to said first direction.

2. The device according to claim 1, wherein said fitting tool and said removal tool protrude, in use, from the same side with respect to said supporting element.

3. The device according to claim 1, wherein said supporting element is locked in rotation.

4. The device according to claim 1, wherein at least one of said tools is associated movable in rotation with said supporting element around a relevant axis of work.

5. The device according to claim 4, further comprising: movement means of at least one of said tools with respect to said supporting element around said axis of work.

6. The device according to claim 4, wherein at least one of either said fitting tool or said removal tool is movable in rotation with respect to the other around an axis of rotation transverse to said first direction to displace along said direction of work.

7. The device according to claim 6, wherein said fitting tool and said removal tool are hinged to each other around said axis of rotation.

8. The device according to claim 7, wherein at least one of either said fitting tool or said removal tool is movable in rotation with respect to the other around said axis of rotation.

9. The device according to claim 8, wherein one of said tools is associated idle in rotation with respect to the other around said axis of rotation.

10. The device according to claim 8, wherein said fitting tool and said removal tool are both movable in rotation around said axis of rotation.

11. The device according to claim 10, further comprising: operating means of at least one of said tools along said direction of work.

12. The device according to claim 11, wherein said operating means are adapted to operate in rotation at least one of said tools with respect to the other around said axis of rotation.

13. The device according to claim 12, wherein said operating means comprise at least one actuating device kinematically connected to one of said tools to operate one of the tools in rotation with respect to the other around said axis of rotation.

14. The device according to claim 13, wherein said operating means comprise two of said actuating devices, of which one is kinematically connected to said fitting tool and the other is kinematically connected to said removal tool.

15. The device according to claim 14, wherein said actuating devices comprise a relevant body hinged to said supporting element around a relevant tilting axis and a relevant stem kinematically connected to a corresponding tool, said tools being associated in rotation with said supporting element around said axis of rotation, the latter coinciding with said axis of work.

16. The device according to claim 6, wherein said axis of work is separate from and parallel with respect to said axis of rotation.

17. The device according to claim 15, wherein one of either said fitting tool and said removal tool is hinged to said supporting element around said axis of work and the other of either said fitting tool or said removal tool is movable around said axis of rotation.

18. The device according to claim 1, wherein said first direction is arranged substantially vertically.

19. The device according to claim 17, wherein said fitting tool and said removal tool are locked together along a second direction, close to/away from said rim in a radial pattern and transverse to said first direction, said first direction and said second direction belonging to a common plane, and said axis of rotation is arranged transversely to said common plane.

20. The device according to claim 19, wherein said direction of work is substantially parallel to said second direction.
